(19) United States
(12) Patent Application Publication
(10) Pub. No.: US 2025/0251560 A1
(43) Pub. Date: Aug. 7, 2025

(54) OPTICAL FIBER CABLE INCLUDING A SPLICED FILLER ROD AND METHOD OF FORMING A SPLICED FILLER ROD

(71) Applicant: CORNING RESEARCH & DEVELOPMENT CORPORATION, Corning, NY (US)

(72) Inventor: Sergey Vladimirovich Chernykh, Berlin (DE)

(21) Appl. No.: 19/188,532

(22) Filed: Apr. 24, 2025

Related U.S. Application Data
(63) Continuation of application No. PCT/US2023/036078, filed on Oct. 27, 2023.
(60) Provisional application No. 63/421,304, filed on Nov. 1, 2022.

(51) Int. Cl. G02B 6/44

(52) U.S. Cl. CPC G02B 6/4434; G02B 6/4432; G02B 6/4483

(57) ABSTRACT

Embodiments of the disclosure relate to an optical fiber cable. The optical fiber cable includes a cable jacket having an inner surface and an outer surface. The inner surface defines a central bore extending along a length of the optical fiber cable, and the outer surface defines an outermost surface of the optical fiber cable. A plurality of subunits is disposed within the central bore. The plurality of subunits includes at least one buffer tube containing at least one optical fiber and at least one filler rod. The at least one filler rod is made of a first filler rod portion joined to a second filler rod portion with a splice material.

### CROSS-REFERENCE TO RELATED APPLICATIONS

This application is a continuation of International Patent Application No. PCT/US2023/036078, filed Oct. 27, 2023, which claims the benefit of priority of U.S. Provisional Application No. 63/421,304 filed on Nov. 1, 2022, the content of which is relied upon and incorporated herein by reference in its entirety.

### BACKGROUND

The disclosure relates generally to optical fiber cables and, in particular, to optical fiber cables including filler rods.

Optical fiber cables are deployed in a variety of different operating environments, including aerial, subterranean, underwater, and over the ground. In some environments, the optical fiber cable is carried in a duct. To install the optical fiber cable in the duct, such as by jetting or blowing, the optical fiber cable may need to have a certain diameter relative to the duct. This diameter may not be dictated by the number of optical fibers within the cable, and thus, the space within the cable may be filled with filler rods to maintain the desired shape and structure of the cable.

### SUMMARY

According to an aspect, embodiments of the disclosure relate to an optical fiber cable. The optical fiber cable includes a cable jacket having an inner surface and an outer surface. The inner surface defines a central bore extending along a length of the optical fiber cable, and the outer surface defines an outermost surface of the optical fiber cable. A plurality of subunits is disposed within the central bore. The plurality of subunits includes at least one buffer tube containing at least one optical fiber and at least one filler rod. The at least one filler rod is made of a first filler rod portion joined to a second filler rod portion with a splice material.

According to another aspect, embodiments of the disclosure relate to a method of forming a spliced filler rod for an optical fiber cable. In the method, a first filler rod portion is arranged in a mold passage of a mold. Further, a second filler rod portion is arranged in the mold passage of the mold. A space is provided between the first filler rod portion and the second filler rod portion in the mold passage. A molten splice material is injected through an injection passage into the mold. The injection passage intersects the mold passage such that the molten splice material fills the space between the first filler rod portion and the second filler rod portion. The molten splice material is then cooled to form the spliced filler rod.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments. In the drawings:

FIG. 1 depicts a cross-sectional view of an optical fiber cable, according to an exemplary embodiment;

FIG. 2 depicts mold parts of a mold for forming a splice between portions of a filler rod, according to an exemplary embodiment;

FIGS. 3A and 3B depict angled endfaces of filler rod portions for joining with a splice material, according to an exemplary embodiment;

FIGS. 4A and 4B depict tapered surfaces of filler rod portions for joining with a splice material, according to an exemplary embodiment;

FIG. 5 depicts a molding apparatus for forming a splice between portions of a filler rod, according to an exemplary embodiment;

FIG. 6 depicts splice material joining portions of a filler rod after being released from the mold, according to an exemplary embodiment;

FIGS. 7 and 8 depict tensile test arrangements for the spliced filler rod, according to exemplary embodiments; and

FIGS. 9-11 depict stages of a looping test of the spliced filler rod, according to an exemplary embodiment.

### DETAILED DESCRIPTION

Referring generally to the figures, various embodiments of a spliced filler rod for an optical fiber cable and a method of forming same are provided. As will be discussed more fully below, embodiments of the spliced filler rod include at least two portions of filler rod joined by a splice material in a manner that satisfies relevant criteria for optical fiber cable mechanical reliability.

Optical fiber cables may utilize filler rods in situations where a particular cable diameter is desired (e.g., for blowing within a duct) but where the fiber count does not warrant a cable of that particular size. In such situations, buffer tube subunits of the optical fiber cable may be replaced with filler rods that match the size and general mechanical performance of the buffer tubes. However, cables, including the buffer tube subunits contained therein, are manufactured for particular lengths that may vary depending on customer specifications. The filler rods, on the other hand, may come in spools of standard sizes that do not match the cable length. As such, a spool may run out before the end of a cabling run, requiring the production line to be stopped while the spool of filler rod is replaced. Additionally, there may be excess filler rod remaining at the end of a run that contributes to waste. According to embodiments of the present disclosure, filler rod portions are spliced together such that the filler rod matches the length of the rest of the subunits within the optical fiber cable. In this way, the cable production line does not have to be stopped for changing of filler rod spools, and there is substantially less waste of filler rod material at the end of a run.

Exemplary embodiments of such spliced filler rod for an optical fiber cable and method of forming same will be described in greater detail below and in relation to the figures provided herewith, and these exemplary embodiments are provided by way of illustration, and not by way of limitation.

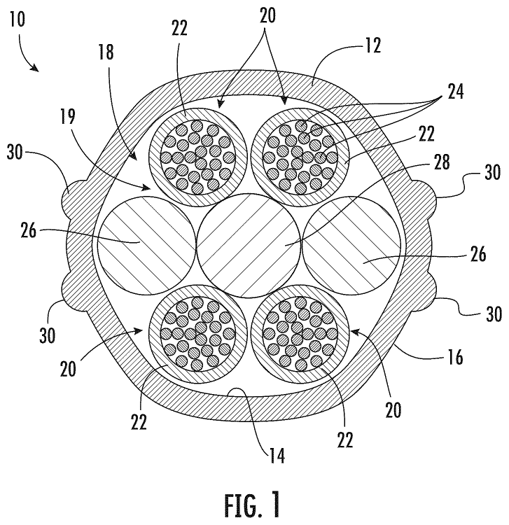

FIG. 1 depicts an example embodiment of an optical fiber cable 10. The optical fiber cable 10 includes a cable jacket 12 having an inner surface 14 and an outer surface 16. The inner surface 14 defines a central bore 18 that extends along the length of the optical fiber cable 10. The outer surface 16 defines an outermost surface of the optical fiber cable 10. In one or more embodiments, the cable jacket 12 is a multilayer structure. In such embodiments, the inner surface 14 is the inner surface of the innermost layer, and the outer surface 16 is the outer surface of the outermost layer. For example, a multilayer cable jacket 12 may contain an interior layer of flame retardant bedding compound and an outer skin layer designed to reduce friction and/or enhance environmental resistance. In such an embodiments, the inner surface of the interior bedding layer may be the inner surface 14 of the cable jacket 12, and the outer surface of the skin layer may be the outer surface 16 of the cable jacket 12.

Disposed within the central bore 18 is a cable core 19 containing a plurality of subunits 20. In the embodiment shown in FIG. 1, the optical fiber cable 10 is known as a “six-position” cable because the cable core 19 contains six subunits 20. However, other optical fiber cable 10 constructions are possible, and the optical fiber cable 10 can include more or fewer subunits 20 in the cable core 19, including multiple layers of subunits 20. In one or more embodiments, the subunits 20 are buffer tubes 22 that contain a plurality of optical fibers 24 or filler rods 26. In one or more embodiments, including the embodiment depicted, the subunits 20 are stranded around a central strength member 28. In one or more embodiments, the optical fiber cable 10 contains as many buffer tubes 22 as needed to provide a desired optical fiber 24 count, and filler rods 26 are provided within the cable jacket 12 to maintain a desired outer diameter of the optical fiber cable 10, e.g., for the purposes of facilitating blowing in a duct. For example, each buffer tube 22 of the optical fiber cable 10 may contain twenty-four optical fibers 24, and a cable core 19 of an optical fiber cable 10 may be designed to contain ninety-six optical fibers 24. In such a case, a six-position optical fiber cable 10 would contain a cable core 19 of four buffer tubes 22 and two filler rods 26. Other combinations of buffer tubes 22 and filler rods 26 are possible (again, depending on the requirements of the optical fiber cable 10).

In one or more embodiments, the buffer tubes 22 and filler rods 26 have substantially the same outer diameter. In one or more embodiments, the filler rods 26 have an outer diameter in a range from 1.6 mm to 4.2 mm, in particular from 2.2 mm to 2.8 mm. In one or more embodiments, the filler rods 26 are formed from a polymeric material, such as polyethylene, polypropylene, polybutylene terephthalate, polycarbonate, polyvinylchloride, or polyether-ester block copolymer, among others. In one or more embodiments, the filler rod 26 is a thermoplastic material. In one or more embodiments, the filler rod 26 is foamed at least in portions along its length, and in one or more embodiments the filler rod 26 is solid at least in portions along its length. In one or more embodiments, the filler rod 26 comprises a polymeric material and one or more inorganic filler materials.

In one or more embodiments, the optical fiber cable 10 includes locators 30 formed on the cable jacket 12. In one or more embodiments, including the embodiment of depicted in FIG. 1, the locators 30 are ridges or bumps formed on the surface of the cable jacket 12, but in one or more other embodiments, the locators 30 are depressions formed in the cable jacket 12. The locators 30 extend continuously or discontinuously along the length of the optical fiber cable 10 to provide a tactile indicator of where the cable jacket 12 can be split and to access the cable core 19.

In one or more embodiments, the optical fiber cable 10 optionally includes one or more additional features, such as binding layers (e.g., wraps, tapes, or films), water blocking elements (e.g., yarns, powder, or tapes), tensile elements (e.g., glass, aramid, carbon, or basalt fiber yarns), or armor layers (e.g., metal tapes or wraps), among others.

During manufacture of the optical fiber cable 10, the subunits 20, including buffer tubes 22 and filler rods 26, are paid-off from reels and stranded together or around a central strength member 28 to form the cable core 19. For long runs of cable, the filler rods 26 may not be the same length as the buffer tubes 22, requiring stopping of the production line to change out spools of filler rod 26 and potentially leading to excess waste at the end of the run. Indeed, spools of filler rods 26 may come in standard sizes, whereas the buffer tubes 22 may have lengths corresponding to the desired length of the optical fiber cable 10, which may be custom to a particular installation or a customer's specifications.

According to the present disclosure, embodiments of a method and apparatus for splicing lengths of filler rod 26 together as well as embodiments of a spliced filler rod 26 for an optical fiber cable 10 are disclosed herein. While the following discussion will focus on forming a splice between two portions of a filler rod 26, it should be noted that a filler rod 26 may be spliced multiple times along its length as is needed to provide the desired length of filler rod 26 to match the length of the optical fiber cable 10 (including any excess length needed to account for stranding within the cable core 19).

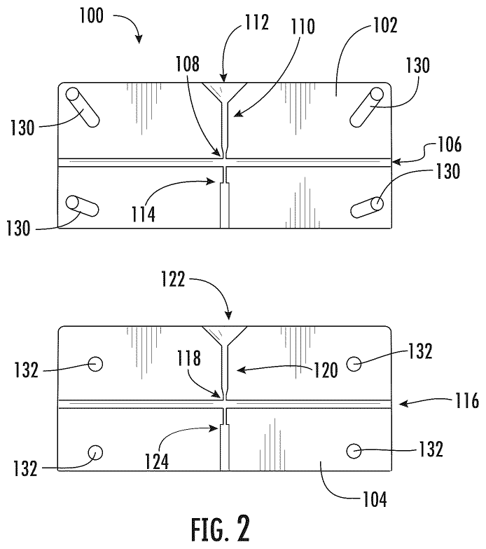

FIG. 2 depicts an embodiment of a mold 100 for splicing ends of a filler rod 26 together. In one or more embodiments, the mold 100 includes a first mold part 102 and a second mold part 104. The first mold part 102 includes a first mold channel 106 extending across the first mold part 102. At approximately a first midpoint 108 of the first mold channel 106, a first injection channel 110 intersects with the first mold channel 106. The first injection channel 110 has a first aperture component 112. In one or more embodiments, the first mold part 102 also includes a first vent channel 114.

The second mold part 104 includes a second mold channel 116 that is complementary to the first mold channel 106. In particular, the first mold channel 106 and the second mold channel 116 form a mold passage configured to hold respective end portions of filler rods 26 in registration during the molding process. At approximately a second midpoint 118 of the second mold channel 116, a second injection channel 120 intersects with the second mold channel 116. The second injection channel 120 is complementary to the first injection channel 110 such that the first injection channel 110 and the second injection channel 120 together form an injection passage for flow of the molten splice material to the mold passage. A second aperture component 122 is formed at one end of the second injection channel 120, and together, the first aperture component 112 and the second aperture component 122 form an aperture to the injection passage through which the molten splice material is received. In one or more embodiments, the second mold part 104 includes a second vent channel 124, and together, the first vent channel 114 and the second vent channel 124 form a vent passage for evacuating air from the mold passage during the molding process.

In one or more embodiments, the first mold part 102 and/or the second mold part 104 includes one or more chambers for thermal control. In particular, the chambers may receive heated or cooled fluids or heating or cooling elements to control the temperature of the mold 100. For example, the mold 100 may be heated to preheat the ends of the filler rods contained therein to facilitate splicing, and/or the mold 100 may be cooled at the end of the molding process.

In one or more embodiments, the first mold part 102 includes first alignment features 130, and the second mold part 104 includes second alignment features 132. In one or more embodiments, including the embodiment shown in FIG. 2, the first alignment feature 130 is a post, and the second alignment feature 132 is a hole configured to receive the post. Other combinations of alignment features are possible, such as a ridge and a corresponding groove or a screw extending through a through hole in one mold part 102/104 to a threaded hole in the other mold part 102/104, amongst other possibilities.

During molding, ends of respective filler rods 26 are arranged in the first mold channel 106 of the first mold part 102. The ends are positioned proximate to the midpoint 108 of the first mold channel 106, and a space is provided between the end portions of the filler rods 26 for receiving molten splice material.

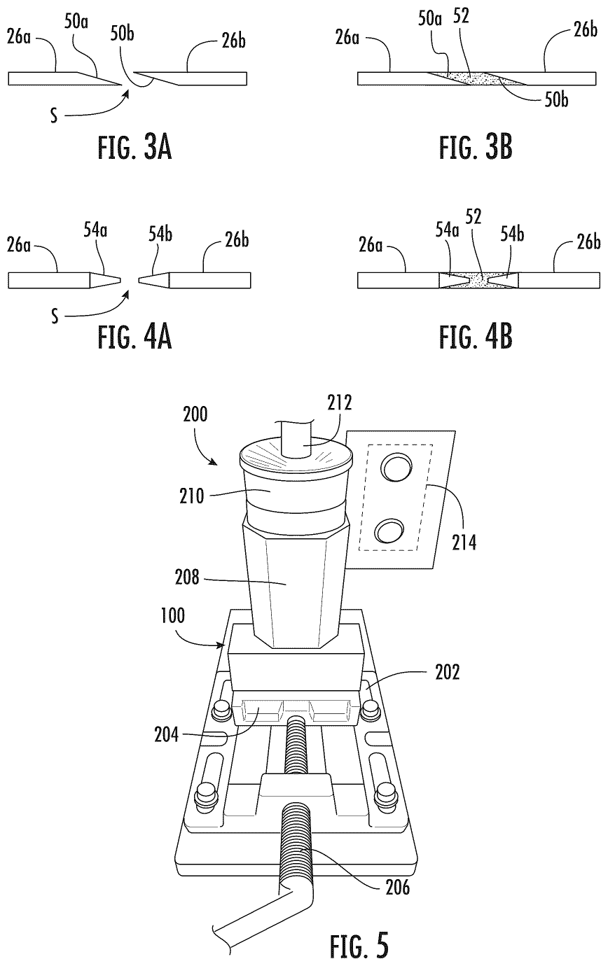

FIGS. 3A-3B and 4A-4B depict examples of how ends of respective filler rod end portions are prepared and positioned during molding. Referring first to FIG. 3A, a first filler rod portion 26a is positioned proximate to a second filler rod portion 26b. A space S is provided between the filler rod portions 26a, 26b. In one or more embodiments, the space S is from 1 mm to 100 mm, in particular 1 mm to 80 mm. Further, the ends of each filler rod portion 26a, 26b are trimmed or shaped to prepare it for splicing. In the embodiment shown in FIG. 3A, the ends are trimmed to form angled endfaces 50a, 50b. As shown in FIG. 3A, the filler rod portions 26a, 26b are arranged such that the angled endfaces 50a, 50b are complementary. That is, the first filler rod portion 26a is positioned such that the first angled endface 50a is tapered across the diameter from an upper edge to a lower edge, and the second filler rod portion 26b is positioned such that the second angled endface 50b is tapered across the diameter from the lower edge to the upper edge.

As shown in FIG. 3B, a splice material 52 fills the space S between the filler rod portions 26a, 26b and bonds to the angled endfaces 50a, 50b to join the first filler rod portion 26a to the second filler rod portion 26b. In one or more embodiments, the angles of the angled endfaces 50a, 50b can be increased or decreased. For example, decreasing the angles of the angled endface 50a, 50b increases the length of the angled endfaces 50a, 50b such that a larger bonding surface is created between the angled endfaces 50a, 50b and the splice material 52. Notwithstanding, the angles of the angled endfaces 50a, 50b can be increased and the space S between angled endfaces 50a, 50b decreased to decrease the amount of splice material 52 utilized, creating cost savings while also providing a bond sufficient to withstand the expected mechanical loads associated with cable assembly.

As shown in FIG. 4A, a first filler rod portion 26a is positioned proximate to a second filler rod portion 26b and separated by a space S. The filler rod portions 26a, 26b are shaped or trimmed to form tapered surfaces 54a, 54b. That is, the filler rod portions 26a, 26b taper in thickness from the outer surface toward the center of the filler rod portions 26a, 26b to form multi-faceted (e.g., wedge-shaped, tetrahedral, pyramidal, etc.) or conical tapered surfaces 54a, 54b. As shown in FIG. 4B, the splice material 52 fills the space S between the filler rod portions 26a, 26b and bonds to the tapered surfaces 54a, 54b to join the first filler rod portion 26a to the second filler rod portion 26b.

FIG. 5 depicts a molding apparatus 200 for forming a splice between filler rod portions 26. The molding apparatus 200 includes a base 202 configured to hold the mold 100. A clamp 204 is used to lock the mold 100 in place on the base 202. In one or more embodiments, the clamp 204 translates across the base 202 using a linear actuator 206, such as a ball screw. The clamp 204 positions the mold 100 on the base 202 such that the mold 100 is positioned under an extrusion barrel 208. The extrusion barrel 208 is provided with splice material feedstock through a hopper 210, and the feedstock is pushed through the hopper 210 with a ram 212. The molding apparatus 200 further includes a control panel 214 to initiate and terminate the molding process. In one or more embodiments, the molding process involves feeding the hopper 210 with splice material feedstock, driving the feedstock through the hopper 210 and into the extrusion barrel 208 via the ram, melting the feedstock within the extrusion barrel 208, and injecting the molten feedstock into the mold 100.

The filler rod 26 is made of a polymeric material, and the splice material 52 is also made of a polymeric material. In one or more embodiments, the splice material 52 is made of the same polymeric material as the filler rod 26. For example, the filler rod 26 may be made of polypropylene, and the splice material 52 may also be made of polypropylene. In one or more embodiments, the splice material 52 is made of a polymeric material that is compatible with the polymeric material of the filler rod 26. For example, the filler rod 26 may be made of polyethylene, and the splice material 52 may be made of ethyl-vinyl acetate copolymer. Advantageously, the molding process can be performed “cold,” i.e., the portions of the filler rod 26 to be joined can be at room temperature (e.g., 23° C.) and do not need to be melted to form an adequate splice with the splice material 52. As mentioned above, the mold 100 may be heated to preheat the portions of the filler rod 26. Further, in one or more embodiments, injection of the molten splice material into the mold 100 heats the mold 100 so as to preheat the portions of the filler rod 26. Alternatively or additionally, the portions of the filler rod 26 may be heated before being inserted into the mold 100. In one or more embodiments, the portions of the filler rod 26 are preheated to a temperature in a range that is 10° C. to 20° C. lower than the Vicat softening point to prevent significant deformation of the portions of the filler rod 26 during splicing.

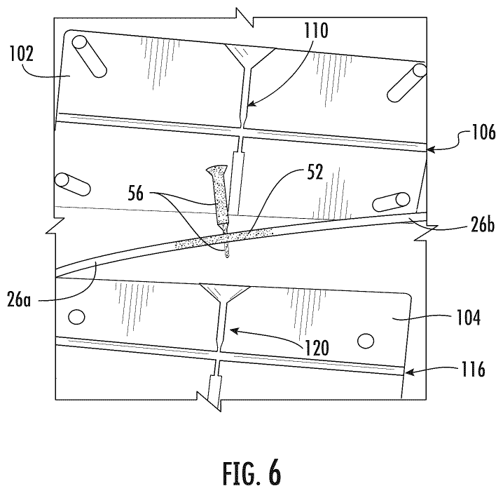

FIG. 6 depicts the spliced filler rod portions 26a, 26b upon release from the mold parts 102, 104. As shown in FIG. 6, the spliced filler rod portions 26a, 26b are joined by the splice material 52, and mold runners 56 extend from the splice material 52. These mold runners 56 can be trimmed to provide the filler rod 26 for the optical fiber cable 10. As shown in FIG. 6, the first and second injection channels 110, 120 can taper near the first and second mold channels 106, 116 to facilitate removal of the runners 56. For example, the portion of the runner 56 near the splice may be thin enough that the runners 56 can be torn from the filler rod 26 by hand. As mentioned above, the filler rod portions 26a, 26b are spliced to form a filler rod 26 having a desired length based on the length of the optical fiber cable 10. In this way, the optical fiber cable production line does not need to be stopped during stranding of the subunits 20, and excess length of filler rod material is not wasted (in particular, because excess filler rod material can be spliced to another spool of filler rod material).

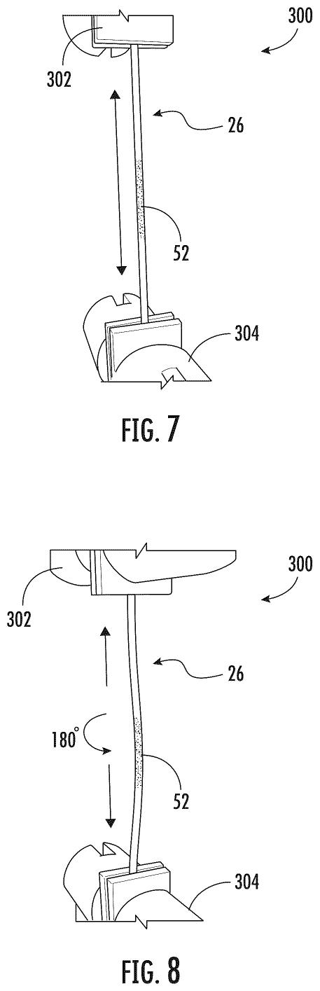

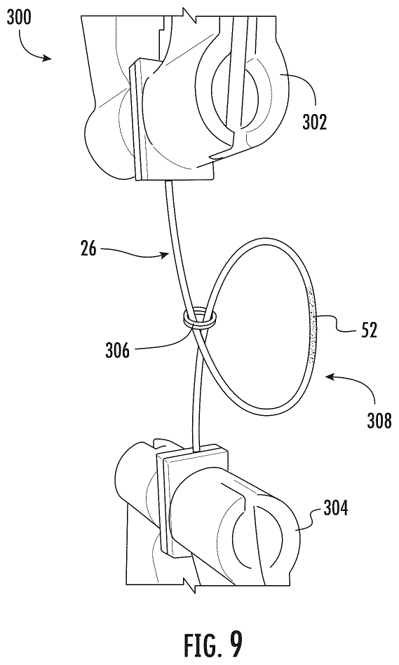

As shown in FIGS. 7-11, the spliced filler rod 26 was tested for mechanical reliability according to a variety of tests. As shown in FIG. 7, the spliced filler rod 26 was arranged in testing apparatus 300 in which ends of the spliced filler rod 26 were fixed in respective clamps 302, 304, and the clamps 302, 304 were moved apart to apply tension to the spliced filler rod 26 until the spliced filler rod 26 failed. FIG. 8 depicts another arrangement of the testing apparatus 300 in which the spliced filler rod 26 was twisted 180° before tension was applied. In particular, one end of the spliced filler rod 26 was fixed in the first clamp 302, the spliced filler rod 26 was twisted 180°, and then the other end of the spliced filler rod 26 was fixed in the second clamp 304. Thereafter, the clamps 302, 304 were moved apart to apply tension to the twisted spliced filler rod 26. The tensile properties of the spliced filler rod 26 according to the tensile testing shown in FIGS. 7 and 8 is summarized in Table 1, below.

TABLE 1
Tensile Strength of Spliced Filler Rod

| | Yield | | Break | Break | Elongation |
|---|---|---|---|---|---|
| | Stress | Strain at | Load | Stress | at Break |
| | (MPa) | Yield (%) | (N) | (MPa) | (%) |
| Control | 22.5 | 7.6 | 113.6 | 24.1 | >600 |
| Spliced (angled | 22.3 | 6.7 | 104.9 | 22.3 | 174.0 |
| endface) | | | | | |
| Spliced (tapered | 22.1 | 7.4 | 104.2 | 22.1 | 159.9 |
| surface) | | | | | |
| Twisted, spliced | 22.6 | 8.3 | 106.3 | 22.5 | 149.6 |
| (angled endface) | | | | | |
| Twisted, spliced | 22.4 | 7.5 | 106.8 | 22.6 | 275.2 |
| (tapered | | | | | |
| surfaces) | | | | | |

In Table 1, the tensile properties of the spliced filler rod 26 are provided and compared to an unspliced control sample. The control sample was a filler rod made of foamed general grade polypropylene, having a diameter of 2.5 mm. The spliced filler rods 26 were made of foamed general grade polypropylene and were joined with a splice material of unfoamed polypropylene (Achieve™ Advance PP3854 available from ExxonMobil Corporation, Irving, TX). The spliced filler rods 26 also had a diameter of 2.5 mm. Two sets of at least five spliced filler rods 26 were spliced using angled endfaces 50a, 50b as shown in FIGS. 3A-3B. One set of at least five filler rods 26 with angled endfaces 50a, 50b was subjected to testing as shown in FIG. 7, and one set of at least five filler rods 26 with angled endfaces 50a, 50b was subjected testing as shown in FIG. 8. Two further sets of at least five spliced filler rods 26 were spliced using tapered surfaces 54a, 54b as shown in FIGS. 4A-4B. One set of the at least five filler rods 26 with tapered surfaces 54a, 54b was subjected to testing as shown in FIG. 7, and one set of at least five filler rods with tapered surfaces 54a, 54b was subjected to testing as shown in FIG. 8. The tensile properties reported in Table 1 represent the average of the at least five specimens for each set.

As can be seen, the control sample exhibited a yield stress of 22.5 M Pa and a strain at yield of 7.6%. The break load was 113.6 N, and the break stress was 24.1 M Pa. The elongation at break was greater than 600%.

For the spliced filler rod 26 with angled endfaces 50a, 50b, the yield stress during tensile testing (FIG. 7) was 22.3 M Pa, and the strain at yield was 6.7%. The break load was 104.9 N, the break stress was 22.4 M Pa, and the elongation at break was 174.0%. When twisted and subject to tensile testing (FIG. 8), the spliced filler rod 26 with angled endfaces 50a, 50b exhibited a yield stress of 22.6 M Pa and a strain at yield of 8.3%. The break load was 106.3 N, the break stress was 22.5 M Pa, and the elongation at break was 149.6%.

For the spliced filler rod 26 with tapered surfaces 54a, 54b, the yield stress during tensile testing (FIG. 7) was 22.1 M Pa, and the strain at yield was 7.4%. The break load was 104.2 N, the break stress was 22.1 M Pa, and the elongation at break was 159.9%. When twisted and subject to tensile testing (FIG. 8), the spliced filler rod 26 with tapered endfaces 54a, 54b exhibited a yield stress of 22.4 M Pa, and the strain at yield was 7.5%. The break load was 106.8 N, the break stress was 22.6 M Pa, and the elongation at break was 275.2.

Thus, the splice material 52 was sufficient to reliably join the filler rods 26a, 26b with very little diminishment of mechanical properties. In particular, the yield stress and the strain at yield were essentially unchanged, and the break load and break stress were minimally impacted. In one or more embodiments, the break load and break stress of the spliced filler rod as tested across the splice material 52 are at least 90% of the break load and break stress of an unspliced portion of filler rod. The inventor surmises that the elongation at break was diminished because of the use of an unfoamed splice material (the foamed material being more deformable). Advantageously, the tensile strength of the spliced filler rod 26 is well above the typical tensile load experienced by the filler rod 26 during cable processing, such as during stranding (typically up to 30 N). Accordingly, the tensile stress and twisted tensile stress measurements demonstrate that the spliced filler rod 26 is suitable for use within an optical fiber cable 10.

The spliced filler rods 26 were subjected to additional testing, including wrapping the spliced filler rods 26 around mandrels of different sizes. According to Telecordia GR-20, subunits 20 are wrapped in three turns around a mandrel having a diameter or 75 mm or around a mandrel having a diameter 20× the diameter of the subunit 20. According to Telecordia GR-20, the subunit 20 is then inspected visually under 5× magnification for any splitting, cracking, or delamination, the presence of which indicates a failed test. In such a test, a mandrel with a smaller diameter will put more stress on the subunit 20, and thus, the spliced filler rod 20 was tested on a 50 mm mandrel (20× the diameter of the spliced filler rod 26) and 25 mm mandrel (10× the diameter of the spliced filler rod 26). No splitting, cracking, or delamination was observed when winding around either of the mandrels, and thus, the spliced filler rod 20 exceeded the requirements of the Telecordia GR-20 standard.

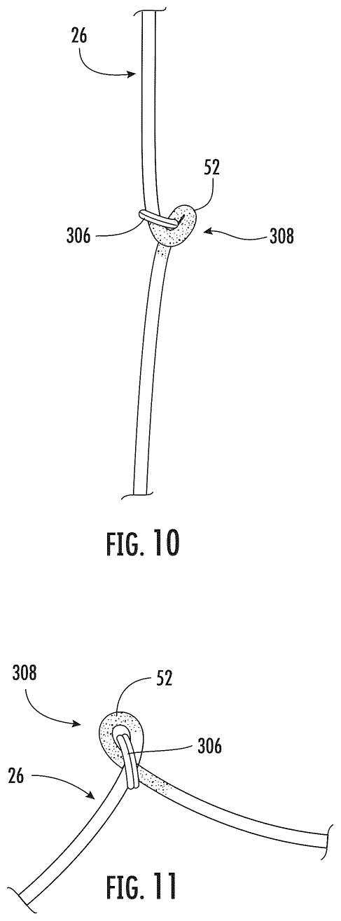

According to a final test, the spliced filler rod 26 was subjected to a loop test to evaluate the resistance of the filler rod 26 to kinking. As shown in FIG. 9, one end of the spliced filler rod 26 was fixed in the first clamp 302 of the testing apparatus 300. The spliced filler rod 26 was passed through a ring 306, and a loop 308 was formed in the spliced filler rod 26 before it was passed back through the ring 306. The other end of the spliced rod 26 was then fixed in the second clamp 304 of the testing apparatus 300. The clamps 302, 304 were moved away from each other such that the loop 308 tightened around the ring 306 as shown in FIG. 10. The loop 308 was tightened in such a way that the splice material 52 was subjected to the most extreme portion of the bending. As shown in FIG. 11, the loop 308 was tightened to a final bend diameter, which was determined to be about 10 mm. The inventor observed that the splice material 52 did not delaminate from the filler rod 26, and no kinking was observed in the spliced filler rod 26. Accordingly, the spliced filler rod 26 exceeds relevant telecommunications requirements for mechanical reliability.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber cable, comprising:
a cable jacket comprising an inner surface and an outer surface, the inner surface defining a central bore extending along a length of the optical fiber cable and the outer surface defining an outermost surface of the optical fiber cable; and
a plurality of subunits disposed within the central bore, the plurality of subunits comprising:
at least one buffer tube containing at least one optical fiber; and
at least one filler rod, the at least one filler rod comprising a first filler rod portion joined to a second filler rod portion with a splice material.

2. The optical fiber cable of claim 1, wherein the first filler rod portion and the second filler rod portion each comprise a first polymeric material, wherein the splice material comprises a second polymeric material, and wherein the first polymeric material and the second polymeric material are a same polymeric material.

3. The optical fiber cable of claim 2, wherein the first polymeric material is foamed.

4. The optical fiber cable of claim 3, wherein the second polymeric material is not foamed.

5. The optical fiber cable of claim 1, wherein the first filler rod portion and the second filler rod portion each comprise a first polymeric material, wherein the splice material comprises a second polymeric material, and wherein the second polymeric material is different from the first polymeric material but compatible with the first polymeric material.

6. The optical fiber cable of claim 1, wherein the first filler rod portion comprises a first angled endface, wherein the second filler rod portion comprises a second angled endface, and wherein the splice material bonds to the first angled endface and the second angled endface.

7. The optical fiber cable of claim 6, wherein a space is provided between the first angled endface of the first filler rod portion and the second angled endface of the second filler rod portion and wherein the splice material is provided in the space.

8. The optical fiber cable of claim 1, wherein the first filler rod portion comprises a first tapered surface, wherein the second filler rod portion comprises a second tapered surface, and wherein the splice material bonds to the first tapered surface and the second tapered surface.

9. The optical fiber cable of claim 8, wherein a space is provided between the first tapered surface of the first filler rod portion and the second tapered surface of the second filler rod portion and wherein the splice material is provided in the space.

10. The optical fiber cable of claim 1, wherein the filler rod is configured to withstand a tensile load of at least 30 N without breaking.

11. The optical fiber cable of claim 1, wherein the filler rod comprises a first diameter and wherein the filler rod is configured to be wound in at least 3 turns around a mandrel having a second diameter, the second diameter being 20× the first diameter, without splitting, cracking, or delaminating according to Telecordia GR-20.

12. The optical fiber cable of claim 1, wherein a length of the first filler rod portion has a first tensile strength at break, wherein the filler rod has a second tensile strength at break as measured across the first filler rod portion, the second filler rod portion, and the splice material, and wherein the second tensile strength is at least 90% of the first tensile strength.

13. A method of forming a spliced filler rod for an optical fiber cable, comprising:
arranging a first filler rod portion in a mold passage of a mold;
arranging a second filler rod portion in the mold passage of the mold, a space being provided between the first filler rod portion and the second filler rod portion in the mold passage;
injecting a molten splice material through an injection passage into the mold, the injection passage intersecting the mold passage such that the molten splice material fills the space between the first filler rod portion and the second filler rod portion; and
cooling the molten splice material to form the spliced filler rod.

14. The method of claim 13, further comprising forming a first angled endface on the first filler rod portion arranged in the mold and forming a second angled endface on the second filler rod portion arranged in the mold.

15. The method of claim 13, further comprising forming a first tapered surface on the first filler rod portion arranged in the mold and forming a second tapered surface on the second filler rod portion arranged in the mold.

16. The method of claim 13, further comprising the step of preheating the first filler rod portion and the second filler rod portion before arranging the first filler rod portion and the second filler rod portion in the mold.

17. The method of claim 13, wherein the first filler rod portion and the second filler rod portion are at room temperature when arranged in the mold.

18. The method of claim 13, wherein the mold comprises a first mold part and a second mold part, the first mold part comprising a first mold channel and a first injection channel that intersects the first mold channel, the second mold part comprising a second mold channel and a second injection channel, wherein the second mold channel complements the first mold channel to form the mold passage and the second injection channel complements the first injection channel to form the injection passage and wherein the method further comprises:
arranging the first filler rod portion and the second filler rod portion in the first mold channel on opposite sides of the first injection channel;
attaching the second mold part to the first mold part such that the first filler rod portion and the second filler rod portion are contained in the mold passage.

19. The method of claim 18, wherein attaching further comprises engaging at least one first alignment feature of the first mold part with at least one second alignment feature of the second mold part.

20. The method of claim 13, further comprising repeating the method until the spliced filler rod reaches or exceeds a planned length of the optical fiber cable.
